(19) United States
(12) Patent Application Publication
(10) Pub. No.: US 2013/0300821 A1
(43) Pub. Date: Nov. 14, 2013

(54) SELECTIVELY COMBINING A PLURALITY OF VIDEO FEEDS FOR A GROUP COMMUNICATION SESSION

(71) Applicants: Richard W. Lankford, San Diego, CA (US); Mark A. Lindner, Superior, CO (US); Shane R. Dewing, San Diego, CA (US); Daniel S. Abplanalp, San Diego, CA (US); Samuel K. Sun, San Diego, CA (US); Anthony Stonefield, San Diego, CA (US)

(72) Inventors: Richard W. Lankford, San Diego, CA (US); Mark A. Lindner, Superior, CO (US); Shane R. Dewing, San Diego, CA (US); Daniel S. Abplanalp, San Diego, CA (US); Samuel K. Sun, San Diego, CA (US); Anthony Stonefield, San Diego, CA (US)

(73) Assignee: QUALCOMM Incorporated, San Diego, CA (US)

(21) Appl. No.: 13/468,908

(22) Filed: May 10, 2012

(51) Int. Cl. H04N 7/15

(52) U.S. Cl. CPC H04N 7/15
USPC 348/14.08

(57) ABSTRACT

In an embodiment, a communications device receives a plurality of video input feeds from a plurality of video capturing devices that provide different perspectives of a given visual subject of interest. The communications device receives, for each of the received plurality of video input feeds, indications of (i) a location an associated video capturing device, (ii) an orientation of the associated video capturing device and (iii) a format of the received video input feed. The communications device selects a set of the received plurality of video input feeds, interlaces the selected video input feeds into a video output feed that conforms to a target format and transmitting the video output feed to a set of target video presentation devices. The communications device can correspond to either a remote server or a user equipment (UE) that belongs to, or is in communication with, the plurality of video capturing devices.

### BACKGROUND OF THE INVENTION

1. Field of the Invention

Embodiments relate to selectively combining a plurality of video feeds for a group communication session.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data, Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1×EV-DO standards, for example) or TD-SCDMA.

Performance within wireless communication systems can be bottlenecked over a physical layer or air interface, and also over wired connections within backhaul portions of the systems.

### SUMMARY

In an embodiment, a communications device receives a plurality of video input feeds from a plurality of video capturing devices that provide different perspectives of a given visual subject of interest. The communications device receives, for each of the received plurality of video input feeds, indications of (i) a location an associated video capturing device, (ii) an orientation of the associated video capturing device and (iii) a format of the received video input feed. The communications device selects a set of the received plurality of video input feeds, interlaces the selected video input feeds into a video output feed that conforms to a target format and transmitting the video output feed to a set of target video presentation devices. The communications device can correspond to either a remote server or a user equipment (UE) that belongs to, or is in communication with, the plurality of video capturing devices.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates a core network according to an embodiment of the present invention.

FIG. 3A is an illustration of a user equipment (UE) in accordance with at least one embodiment of the invention.

FIG. 3B illustrates software and/or hardware modules of the UE in accordance with another embodiment of the invention.

FIG. 4 illustrates a communications device that includes logic configured to perform functionality.

FIG. 5 illustrates a conventional process of sharing video related to a visual subject of interest between UEs when captured by a set of video capturing UEs.

FIG. 6A illustrates a process of selectively combining a plurality of video input feeds from a plurality of video capturing devices to form a video output feed that conforms to a target format in accordance with an embodiment of the invention.

FIG. 6B illustrates an example implementations of a video input feed interlace operation during a portion of FIG. 6A in accordance with an embodiment of the invention.

FIG. 6C illustrates an example implementations of a video input feed interlace operation during a portion of FIG. 6A in accordance with another embodiment of the invention.

FIG. 6D illustrates a continuation of the process of FIG. 6A in accordance with an embodiment of the invention.

FIG. 6E illustrates a continuation of the process of FIG. 6A in accordance with another embodiment of the invention.

FIG. 7A illustrates an example of video capturing UEs in proximity to a city skyline in accordance with an embodiment of the invention.

FIG. 7B illustrates an example of video capturing UEs in proximity to a sports arena in accordance with an embodiment of the invention.

FIG. 8A illustrates an example of interlacing video input feeds to achieve a panoramic view in accordance with an embodiment of the invention.

FIG. 8B illustrates an example of interlacing video input feeds to achieve a plurality of distinct perspective views in accordance with an embodiment of the invention.

FIG. 8C illustrates an example of interlacing video input feeds to achieve a 3D view in accordance with an embodiment of the invention.

FIG. 9 illustrates a process of a given UE that selectively combines a plurality of video input feeds from a plurality of video capturing devices to form a video output feed that conforms to a target format during a local group communication session in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple access terminals.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

As used herein the term interlace, interlaced or interlacing as related to multiple video feeds correspond to stitching or assembling the images or video in a manner to produce a video output feed including at least portions of the multiple video feeds to form for example, a panoramic view, composite image, and the like.

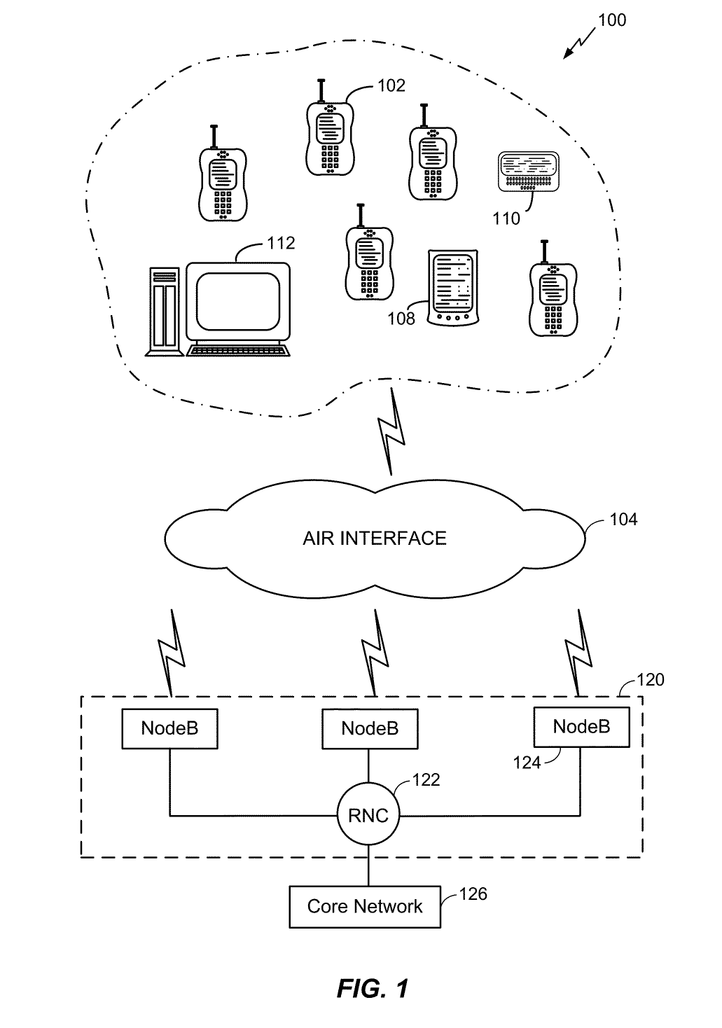

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the UE 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant or tablet computer 108, a pager or laptop 110, which is shown here as a two-way text pager, or even a separate computer platform 112 that has a wireless communication portal. Embodiments of the invention can thus be realized on any form of UE including a wireless communication portal or having wireless communication capabilities, including without limitation, wireless modems, PCMCIA cards, personal computers, telephones, or any combination or sub-combination thereof Further, as used herein, the term “UE” in other communication protocols (i.e., other than W-CDMA) may be referred to interchangeably as an “access terminal,” “AT,” “wireless device,” “client device,” “mobile terminal,” “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

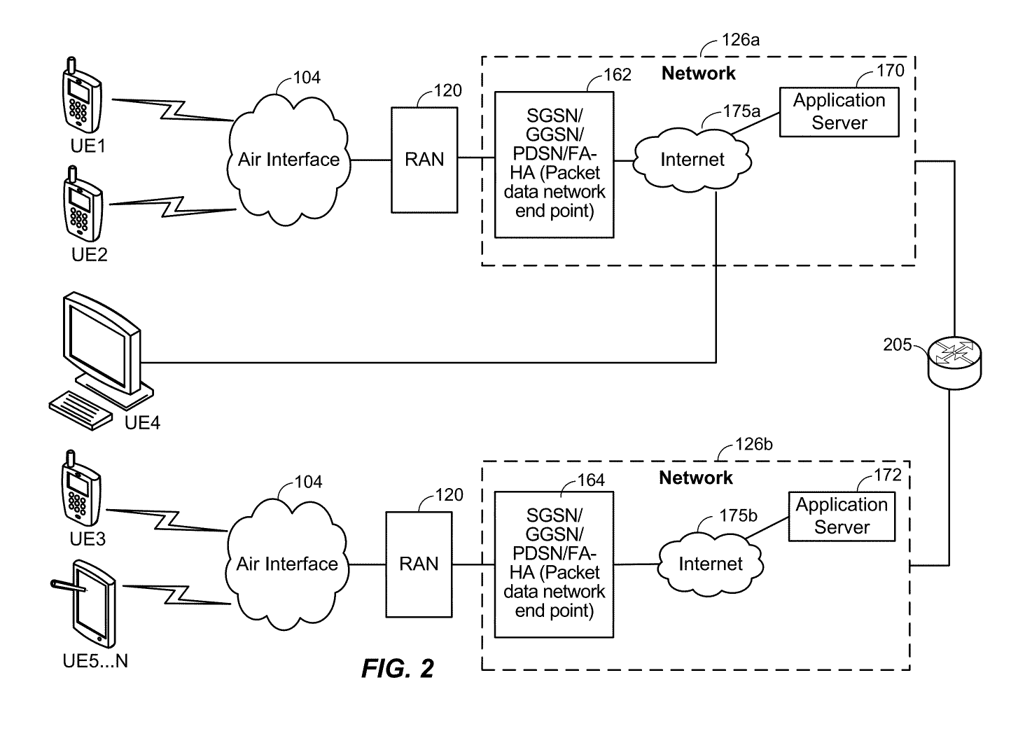

FIG. 2 illustrates an example of the wireless communications system 100 of FIG. 1 in more detail. In particular, referring to FIG. 2, UEs 1 . . . N are shown as connecting to the RAN 120 at locations serviced by different packet data network end-points. The illustration of FIG. 2 is specific to W-CDMA systems and terminology, although it will be appreciated how FIG. 2 could be modified to conform with various other wireless communications protocols (e.g., LTE, EV-DO, UMTS, etc.) and the various embodiments are not limited to the illustrated system or elements.

UEs 1 and 2 connect to the RAN 120 at a portion served by a portion of the core network denoted as 126a, including a first packet data network end-point 162 (e.g., which may correspond to SGSN, GGSN, PDSN, a home agent (HA), a foreign agent (FA), PGW/SGW in LTE, etc.). The first packet data network end-point 162 in turn connects to the Internet 175a, and through the Internet 175a, to a first application server 170 and a routing unit 205. UEs 3 and 5 . . . N connect to the RAN 120 at another portion of the core network denoted as 126b, including a second packet data network end-point 164 (e.g., which may correspond to SGSN, GGSN, PDSN, FA, HA, etc.). Similar to the first packet data network end-point 162, the second packet data network end-point 164 in turn connects to the Internet 175b, and through the Internet 175b, to a second application server 172 and the routing unit 205. The core networks 126a and 126b are coupled at least via the routing unit 205. UE 4 connects directly to the Internet 175 within the core network 126a (e.g., via a wired Ethernet connection, via a WiFi hotspot or 802.11b connection, etc., whereby WiFi access points or other Internet-bridging mechanisms can be considered as an alternative access network to the RAN 120), and through the Internet 175 can then connect to any of the system components described above.

Referring to FIG. 2, UEs 1, 2 and 3 are illustrated as wireless cell-phones, UE 4 is illustrated as a desktop computer and UEs 5 . . . N are illustrated as wireless tablets- and/or laptop PCs. However, in other embodiments, it will be appreciated that the wireless communication system 100 can connect to any type of UE, and the examples illustrated in FIG. 2 are not intended to limit the types of UEs that may be implemented within the system.

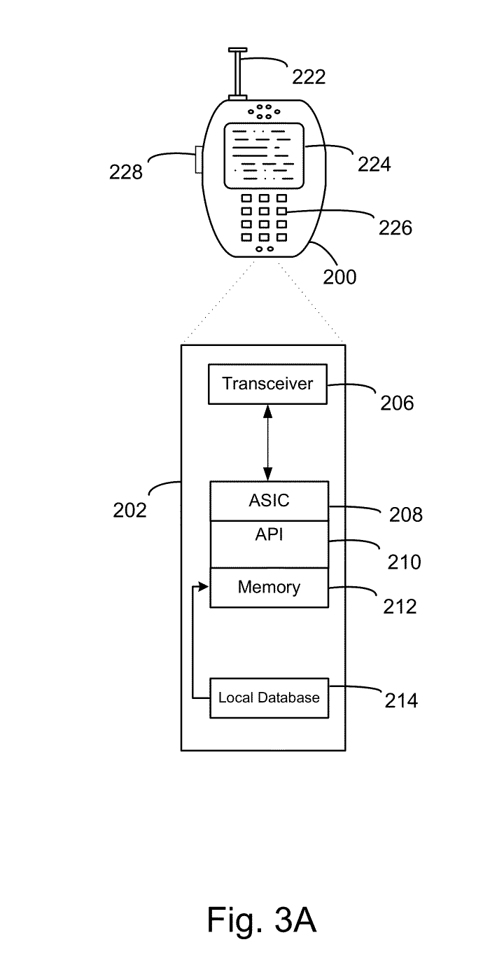

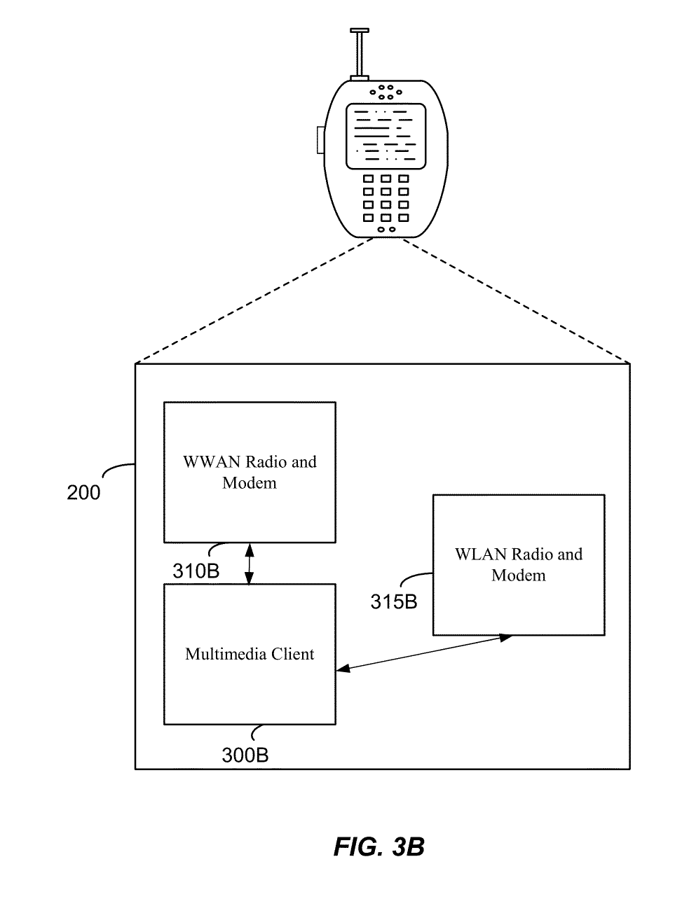

Referring to FIG. 3A, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3A are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), 3GPP Long Term Evolution (LTE) or other protocols that may be used in a wireless communications network or a data communications network. Accordingly, the illustrations provided herein are not intended to limit the embodiments of the invention and are merely to aid in the description of aspects of embodiments of the invention.

FIG. 3B illustrates software and/or hardware modules of the UE 200 in accordance with another embodiment of the invention. Referring to FIG. 3B, the UE 200 includes a multimedia client 300B, a Wireless Wide Area Network (WWAN) radio and modem 310B and a Wireless Local Area Network (WLAN) radio and modem 315B.

Referring to FIG. 3B, the multimedia client 300B corresponds to a client that executes on the UE 200 to support communication sessions (e.g., VoIP sessions, PTT sessions, PTX sessions, etc.) that are arbitrated by the application server 170 or 172 over the RAN 120, whereby the RAN 120 described above with respect to FIGS. 1 through 2 forms part of a WWAN. The multimedia client 300B is configured to support the communication sessions over a personal area network (PAN) and/or WLAN via the WLAN radio and modem 315B.

Referring to FIG. 3B, the WWAN radio and modem 310B corresponds to hardware of the UE 200 that is used to establish a wireless communication link with the RAN 120, such as a wireless base station or cellular tower. In an example, when the UE 200 can establish a good connection with the application server 170, the application server 170 can be relied upon to partially or fully arbitrate the UE 200's communication sessions such that the multimedia client 300B can interact with the WWAN radio modem 310B (to connect to the application server 170 via the RAN 120) to engage in the communication session.

The WLAN radio and modem 315B corresponds to hardware of the UE 200 that is used to establish a wireless communication link directly with other local UEs to form a PAN (e.g., via Bluetooth, WiFi, etc.), or alternatively connect to other local UEs via a local access point (AP) (e.g., a WLAN AP or router, a WiFi hotspot, etc.). In an example, when the UE 200 cannot establish an acceptable connection with the application server 170 (e.g., due to a poor physical-layer and/or backhaul connection), the application server 170 cannot be relied upon to fully arbitrate the UE 200's communication sessions. In this case, the multimedia client 300B can attempt to support a given communication session (at least partially) via a PAN using WLAN protocols (e.g., either in client-only or arbitration-mode).

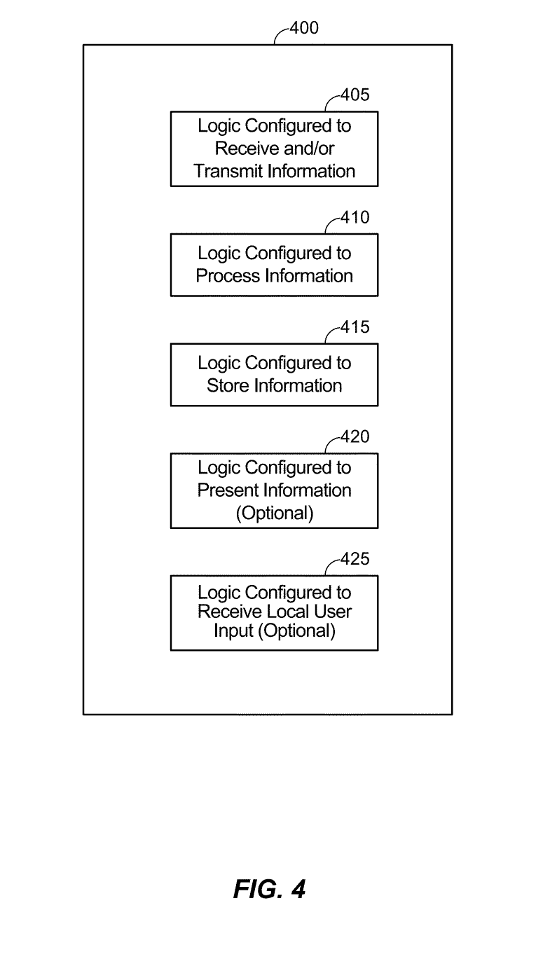

FIG. 4 illustrates a communications device 400 that includes logic configured to perform functionality. The communications device 400 can correspond to any of the above-noted communications devices, including but not limited to UEs 102, 108, 110, 112 or 200, Node Bs or base stations 120, the RNC or base station controller 122, a packet data network end-point (e.g., SGSN, GGSN, a Mobility Management Entity (MME) in Long Term Evolution (LTE), etc.), any of the servers 170 or 172, etc. Thus, communications device 400 can correspond to any electronic device that is configured to communicate with (or facilitate communication with) one or more other entities over a network.

Referring to FIG. 4, the communications device 400 includes logic configured to receive and/or transmit information 405. In an example, if the communications device 400 corresponds to a wireless communications device (e.g., UE 200, Node B 124, etc.), the logic configured to receive and/or transmit information 405 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175a or 175b can be accessed, etc.). Thus, if the communications device 400 corresponds to some type of network-based server (e.g., SGSN, GGSN, application servers 170 or 172, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communications device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communications device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communications device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communications device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communications device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 400. For example, if the communications device 400 corresponds to UE 200 as shown in FIG. 3A, the logic configured to present information 420 can include the display 224. In a further example, the logic configured to present information 420 can be omitted for certain communications devices, such as network communications devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communications device 400 further optionally includes logic configured to receive local user input 425. In an example, the logic configured to receive local user input 425 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communications device 400. For example, if the communications device 400 corresponds to UE 200 as shown in FIG. 3A, the logic configured to receive local user input 425 can include the display 224 (if implemented a touch-screen), keypad 226, etc. In a further example, the logic configured to receive local user input 425 can be omitted for certain communications devices, such as network communications devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

It will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

Multiple video capturing devices can be in view of a particular visual subject of interest (e.g., a sports game, a city, a constellation in the sky, a volcano blast, etc.). For example, it is common for many spectators at a sports game to capture some or all of the game on their respective video capturing devices. It will be appreciated that each respective video capturing device has a distinct combination of location and orientation that provides a unique perspective on the visual subject of interest. For example, two video capturing devices may be very close to each other (i.e., substantially the same location), but oriented (or pointed) in different directions (e.g., respectively focused on different sides of a basketball court). In another example, two video capturing devices may be far apart but oriented (pointed or angled) in the same direction, resulting in a different perspective of the visual subject of interest. In yet another example, even two video capturing devices that are capturing video from substantially the same location and orientation will have subtle differences in their respective captured video. An additional factor that can cause divergence in captured video at respective video capturing devices is the format in which the video is captured (e.g., the resolution and/or aspect ratio of the captured video, lighting sensitivity and/or focus of lenses on the respective video capturing devices, the degree of optical and/or digital zoom, the compression of the captured video, the color resolution in the captured video, whether the captured video is captured in color or black and white, and so on).

In a further aspect, it is now common for video capturing devices to be embodied within wireless communications devices or UEs. Thus, in the sports game example, hundreds or even thousands of spectators to the sports game can capture video at their respective seats in a stadium, with each captured video offering a different perspective of the sports game.

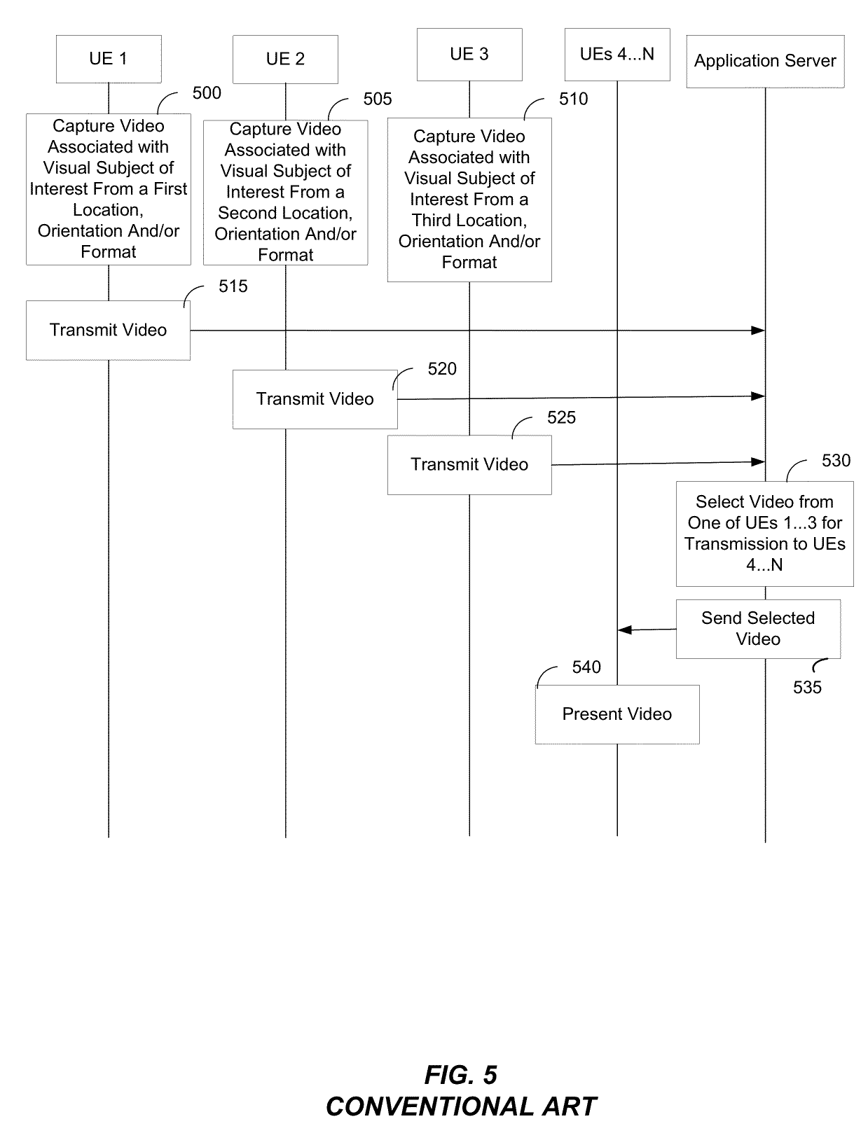

FIG. 5 illustrates a conventional process of sharing video related to a visual subject of interest between UEs when captured by a set of video capturing UEs. Referring to FIG. 5, assume that UEs 1 . . . 3 are each provisioned with video capturing devices and are each connected to the RAN 120 (not shown in FIG. 5 explicitly) through which UEs 1 . . . 3 can upload respective video feeds to the application server 170 for dissemination to target UEs 4 . . . N. With these assumptions in mind, UE 1 captures video associated with a given visual subject of interest from a first location, orientation and/or format, 500, UE 2 captures video associated with the given visual subject of interest from a second location, orientation and/or format, 505, and UE 3 captures video associated with the given visual subject of interest from a third location, orientation and/or format, 510. As noted above, one or more of the locations, orientations and/or formats associated with the captured video by UEs 1 . . . 3 at 500 through 510 can be the same or substantially the same, but the respective combinations of location, orientation and format will have, at the minimum, subtle cognizable differences in terms of their respective captured video. UE 1 transmits its captured video as a first video input feed to the application server 170, 515, UE 2 transmits its captured video as a second video input feed to the application server 170, 520, and UE 3 transmits its captured video as a third video input feed to the application server 170, 525. While not shown explicitly in FIG. 5, the video feeds from UEs 1 . . . 3 can be accompanied by supplemental information such as audio feeds, subtitles or descriptive information, and so on.

Referring to FIG. 5, the application server 170 receives the video input feeds from UEs 1 . . . 3 and selects one of the video feeds for transmission to UEs 4 . . . N, 530. The selection at 530 can occur based on the priority of the respective UEs 1 . . . 3, or manually based on an operator of the application server 170 inspecting each video input feed and attempting to infer which video input feed will be most popular or relevant to target UEs 4 . . . N. The application server 170 then forwards the selected video input feed to UEs 4 . . . N as a video output feed, 535. UEs 4 . . . N receive and present the video output feed, 540.

As will be appreciated by one of ordinary skill in the art, the application server 170 in FIG. 5 can attempt to select one of the video input feeds from UEs 1 . . . 3 to share with the rest of the communication group. However, in the case where the application server 170 selects a single video input feed, the other video input feeds are ignored and are not conveyed to the target UEs 4 . . . N. Also, if the application server 170 selected and forwarded multiple video input feeds and sent these multiple video input feeds in parallel to target UEs 4 . . . N, it will be appreciated that the amount of bandwidth allocated to the video output feed would need to scale with the number of selected video input feeds, which may be impractical and may strain both carrier networks as well as the target UEs themselves for decoding all the video data. Accordingly, embodiments of the invention are directed to selectively combining a plurality of video input feeds in accordance with a target format that preserves bandwidth while enhancing the video information in the video output frame over any particular video input feed.

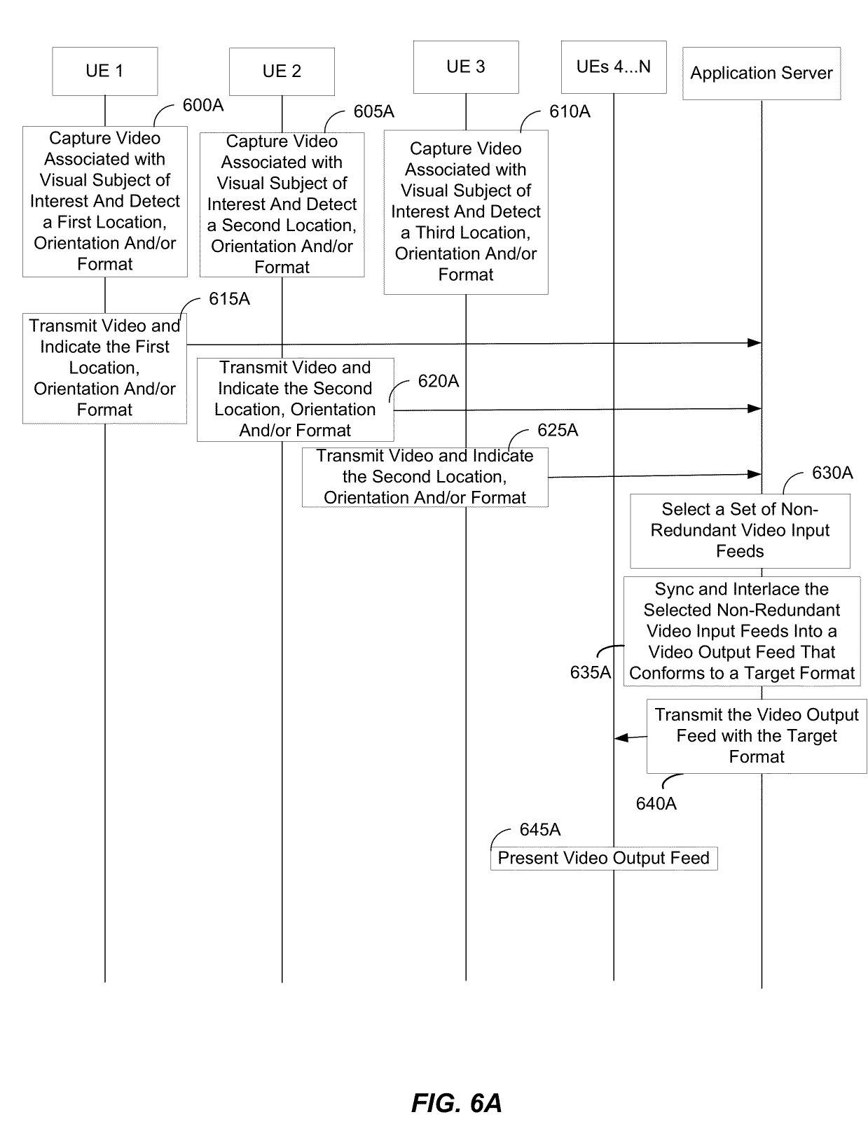

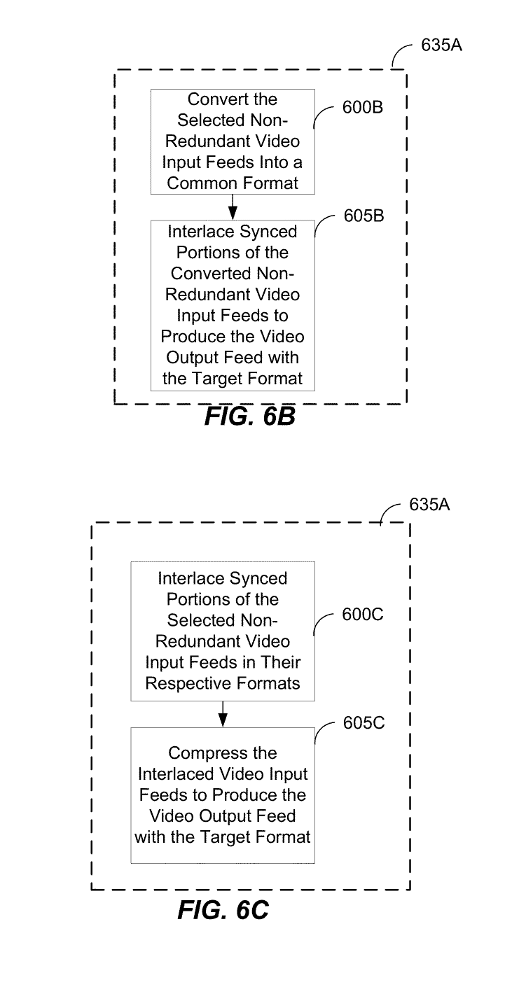

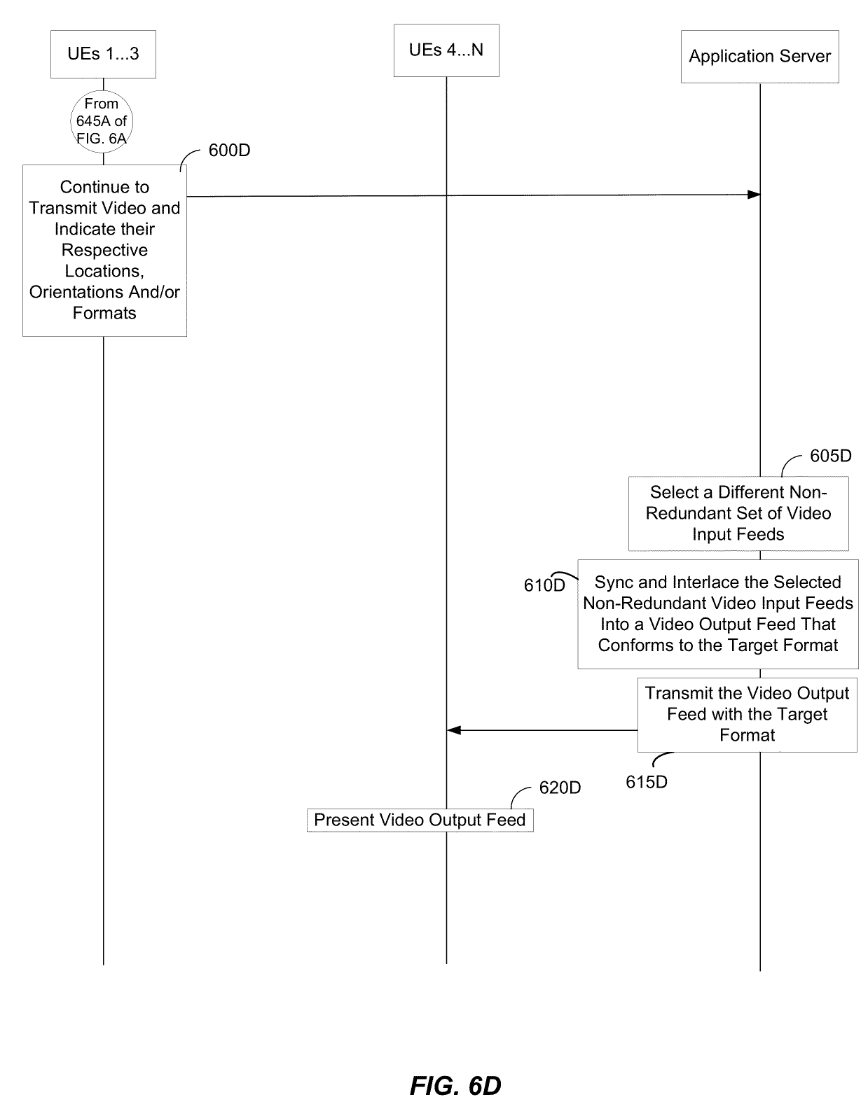

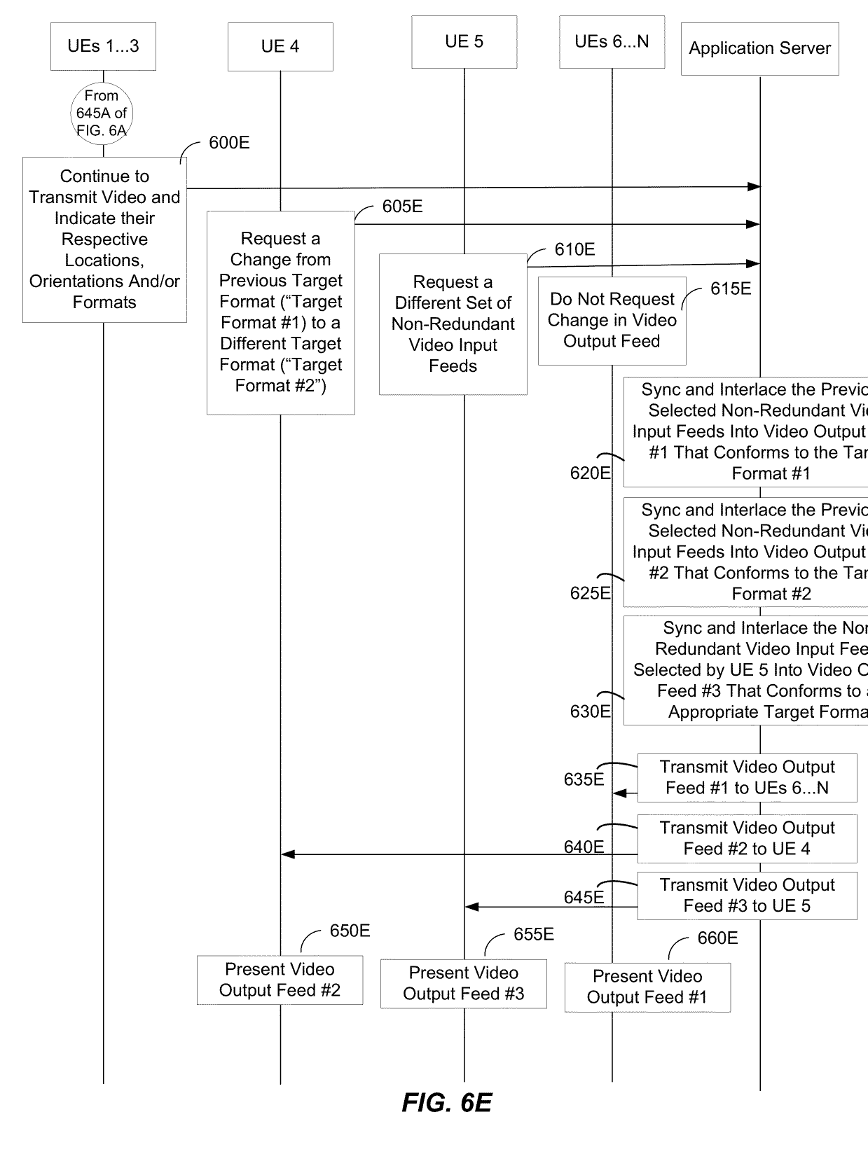

FIG. 6A illustrates a process of selectively combining a plurality of video input feeds from a plurality of video capturing devices to form a video output feed that conforms to a target format in accordance with an embodiment of the invention.

Referring to FIG. 6A, assume that UEs 1 . . . 3 are each provisioned with video capturing devices and are each connected to the RAN 120 (not shown in FIG. 5 explicitly) or another type of access network (e.g., a WiFi hotspot, a direct or wired Internet connection, etc.) through which UEs 1 . . . 3 can upload respective video feeds to the application server 170 for dissemination to one or more of target UEs 4 . . . N. With these assumptions in mind, UE 1 captures video associated with a given visual subject of interest from a first location, orientation and/or format, 600A, UE 2 captures video associated with the given visual subject of interest from a second location, orientation and/or format, 605A, and UE 3 captures video associated with the given visual subject of interest from a third location, orientation and/or format, 610A. As noted above, one or more of the locations, orientations and/or formats associated with the captured video by UEs 1 . . . 3 at 600A through 610A can be the same or substantially the same, but the respective combinations of location, orientation and format will have, at the minimum, subtle cognizable differences in terms of their respective captured video.

Unlike FIG. 5, in FIG. 6A assume that in addition to capturing the video at UEs 1 . . . 3 at 600A through 610A, UEs 1 . . . 3 also detect their respective location, orientation and format for the captured video. For example, UE 1 may detect its location using a satellite positioning system (SPS) such as the global positioning system (GPS), UE 1 may detect its orientation via a gyroscope in combination with a tilt sensor and UE 1 may detect its format via its current video capture settings (e.g., UE 1 may detect that current video is being captured at 480p in color and encoded via H.264 at 2× digital zoom and 2.5× optical zoom). In another example, UE 2 may determine its location via a terrestrial positioning technique, and UE 3 may detect its location via a local wireless environment or radio frequency (RF) fingerprint (e.g., by recognizing a local Bluetooth connection, WiFi hotspot, cellular base station, etc.). In another example, UE 2 may report a fixed location, such as seat #4F in section #22 of a particular sports stadium.

In another example, the respective UEs may report their locations as relative to other UEs providing video input feeds to the application server 170. In this case, the P2P distance and orientation between the disparate UEs providing video input feeds can be mapped out even in instances where the absolute location of one or more of the disparate UEs is unknown. This may give the rendering device (i.e., the application server 170 in FIG. 6A) the ability to figure out the relationship between the various UEs more easily. The relative distance and angle between the devices will allow the 3D renderer (i.e., the application server 170 in FIG. 6A) to determine when a single device shifts its position (relative to a large group, it will be the one that shows changes in relation to multiple other devices).

Accordingly, there are various mechanisms by which UEs 1 . . . 3 can determine their current locations, orientations and/or formats during the video capture.

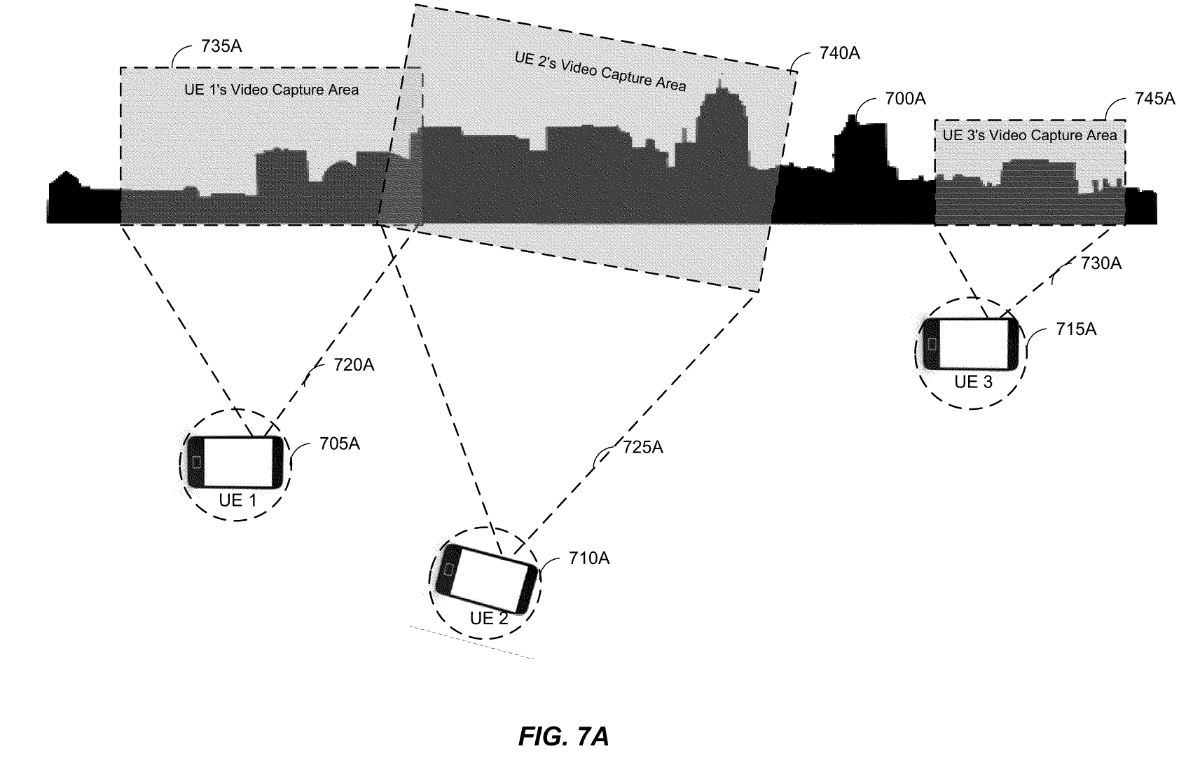

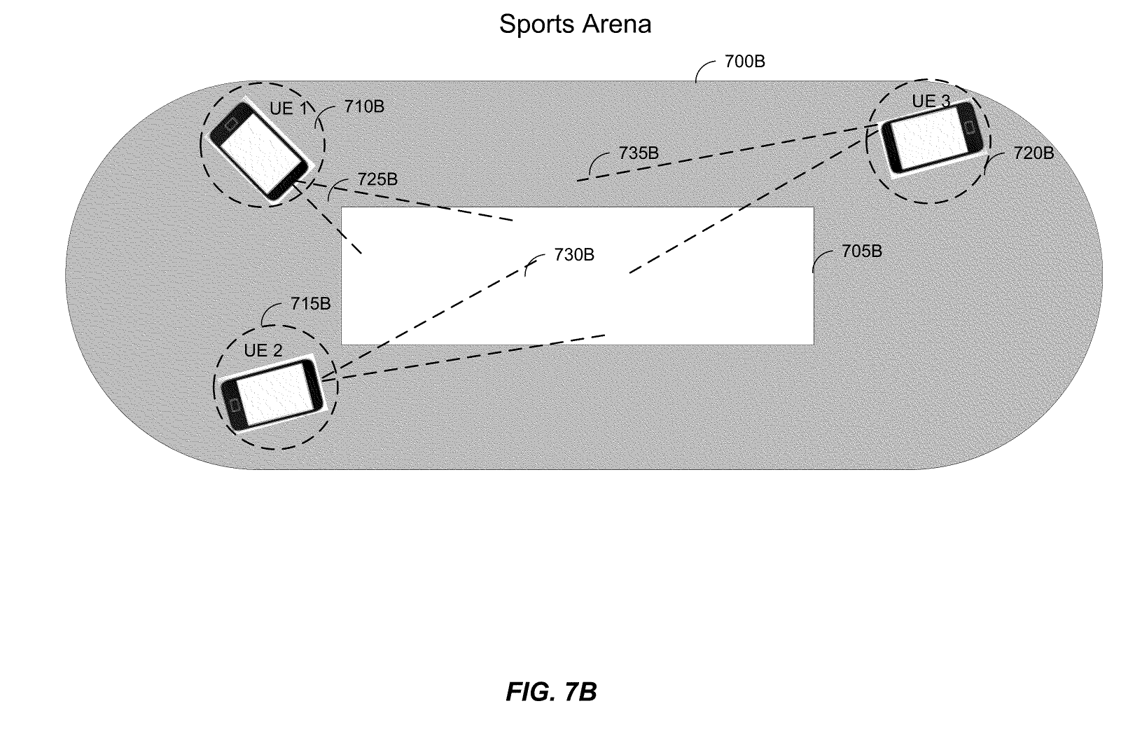

Turning briefly to FIGS. 7A-7B, examples of the locations and orientations of the UEs 1 . . . 3 during the video capture of 600A through 610A are provided. With reference to FIG. 7A, the visual subject of interest is a city skyline 700A, and UEs 1 . . . 3 are positioned at locations 705A, 710A and 715A in proximity to the city skyline 700A. The orientation of UEs 1 . . . 3 is represented by the video capture lobes 720A, 725A and 730A. Basically, video capturing devices embedded or attached to UEs 1 . . . 3 are pointed towards the city skyline 700A so as to capture light along the respective video capture lobes (or line of sight). Based on the various format settings of the respective video capture devices on UEs 1 . . . 3 (e.g., the level of zoom, focus, etc.), UEs 1 . . . 3 are capturing portions of the city skyline 700A represented by video capture areas 735A, 740A and 745A.

With reference to FIG. 7B, UEs 1 . . . 3 are each spectators at a sports arena 700B with the visual subject of interest corresponding to the playing court or field 705B, and UEs 1 . . . 3 are positioned at locations 710B, 715B and 720B in proximity to the playing court or field 705B (e.g., at their respective seats in the stands or bleachers). The orientation of UEs 1 . . . 3 is represented by the video capture lobes 725B, 730B and 735B. Basically, video capturing devices embedded or attached to UEs 1 . . . 3 are pointed towards the playing court or field 705B so as to capture light along the respective video capture lobes (or line of sight).

Returning to FIG. 6A, during the group communication session, UE 1 transmits its captured video as a first video input feed to the application server 170 along with an indication of the first location, orientation and/or format, 615A, UE 2 transmits its captured video as a second video input feed to the application server 170 along with an indication of the second location, orientation and/or format, 620A, and UE 3 transmits its captured video as a third video input feed to the application server 170 along with an indication of the third location, orientation and/or format, 625A. While not shown explicitly in FIG. 6A, the video feeds from UEs 1 . . . 3 can be accompanied by supplemental information such as audio feeds, subtitles or descriptive information, and so on.

Referring to FIG. 6A, the application server 170 receives the video input feeds from UEs 1 . . . 3 and selects a set of more than one of the video input feeds for transmission to one or more of UEs 4 . . . N, 630A. In particular, the selection selects a set of “non-redundant” video input feeds relative to the particular target format to be achieved in the resultant video output feed. For example, if the target format corresponds to a panoramic view of a city skyline, then video input feeds showing substantially overlapping portions of the video input feeds are redundant because an interlaced version of the video input feeds would not expand much beyond the individual video input feeds. On the other hand, video input feeds that capture non-overlapping portions of the city skyline are good candidates for panoramic view selection because the non-overlapping portions are non-redundant. Similarly, if the target format is providing a target UE with a multitude of diverse perspective views of the city skyline, video input feeds that focus on the same part of the city skyline are also redundant. In another example, if the target format corresponds to a 3D view, the video input feeds are required to be focused on the same portion of the city skyline because it would be difficult to form a 3D view of totally distinct and unrelated sections of the city skyline. However, in the context of a 3D view, video input feeds that have the same orientation or angle are considered redundant, because orientation diversity is required to form the 3D view. Thus, the definition of what makes video input feeds “redundant” or “non-redundant” can change with the particular target format to be achieved. By choosing appropriate (i.e., non-redundant) video input feeds at 630A, the success rate of achieving the target format and/or quality of the target format can be improved.

In yet another example of non-redundant video input feed detection and selection, the above-described relative P2P relationship information (e.g., the distance and orientation or angle between respective P2P UEs in lieu of, or in addition to, their absolute locations) can be used to disqualify or suppress redundant video input feeds. In the 3D view scenario, for instance, the relative P2P relationship between P2P devices can be used to detect video input feeds that lack sufficient angular diversity for a proper 3D image.

While not shown explicitly in FIG. 6A, if local P2P UEs become aware that they share a close location as well as a similar vantage point (e.g., a similar angle or orientation), the local P2P UEs can negotiate with each other so that only one of the local P2P UEs transmits a video input feed at 615A through 625A (e.g., the P2P UE with higher bandwidth, etc.). Thus, in some embodiments, the redundant video input feeds can be reduced via P2P negotiation among the video capturing UEs, which can simplify the subsequent selection of the video input feeds for target format conversion at 630A.

After selecting the set of non-redundant video input feeds for a particular target format, the application server 170 then syncs and interlaces the selected non-redundant video input feeds from 630A into a video output feed that conforms to the target format, 635A. In terms of syncing the respective video input feeds, the application server 170 can simply rely upon timestamps that indicate when frames in the respective video input feed are captured, transmitted and/or received. However, in another embodiment, event-based syncing can be implemented by the application server 170 using one or more common trackable objects within the respective video input feeds. For example, if the common visual subject of interest is a basketball game and the selected non-redundant video input feeds are capturing the basketball game from different seats in a stadium, the common trackable objects that the application server 170 will attempt to “lock in” or focus upon for event-based syncing can include the basketball, lines on the basketball court, the referees' jerseys, one or more of the players' jerseys, etc. In a specific example, if a basketball player shoots the basketball at a particular point in the game, the application server 170 can attempt to sync when the basketball is shown as leaving the hand of the basketball player in each respective video input feed to achieve the event-based syncing. As a general matter, good candidates for the common trackable objects to be used for event-based syncing include a set of high-contrast objects that are fixed and a set of high-contrast objects that are stationary (with at least one of each type being used). Each UE providing one of the video input feeds can be asked to report parameters such as its distance and angle (i.e., orientation or degree) to a set of common trackable objects on a per-frame basis or some other periodic basis. At the application server 170, the distance and angle information to a particular common tracking object permits the application server 170 to sync between the respective video input feeds. Once the common tracking objects are being tracked, events associated with the common tracking objects can be detected at multiple different video input feeds (e.g., the basketball is dribbled or shot into a basket), and these events can then become a basis for syncing between the video input feeds. In between these common tracking object events, the disparate video input feeds can be synced via other means, such as timestamps as noted above.

The selection and interlacing of the video input feeds at 630A through 635A can be implemented in a number of ways, as will now be described.

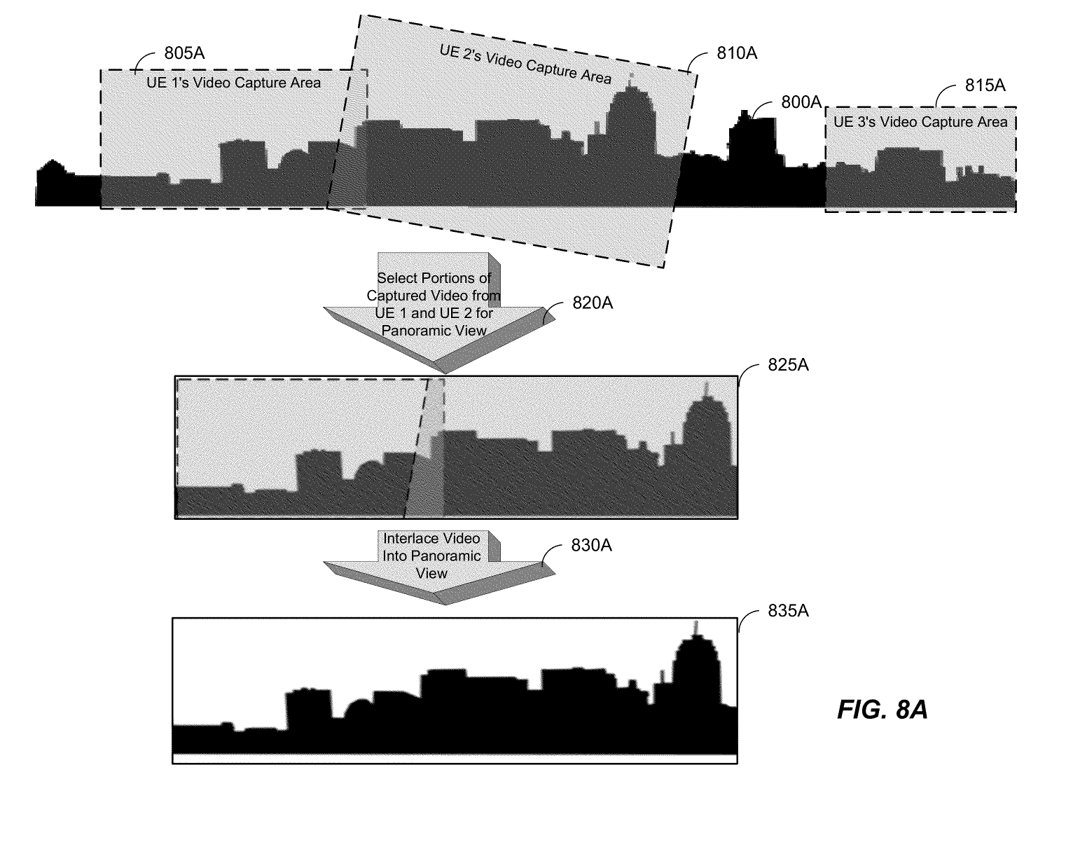

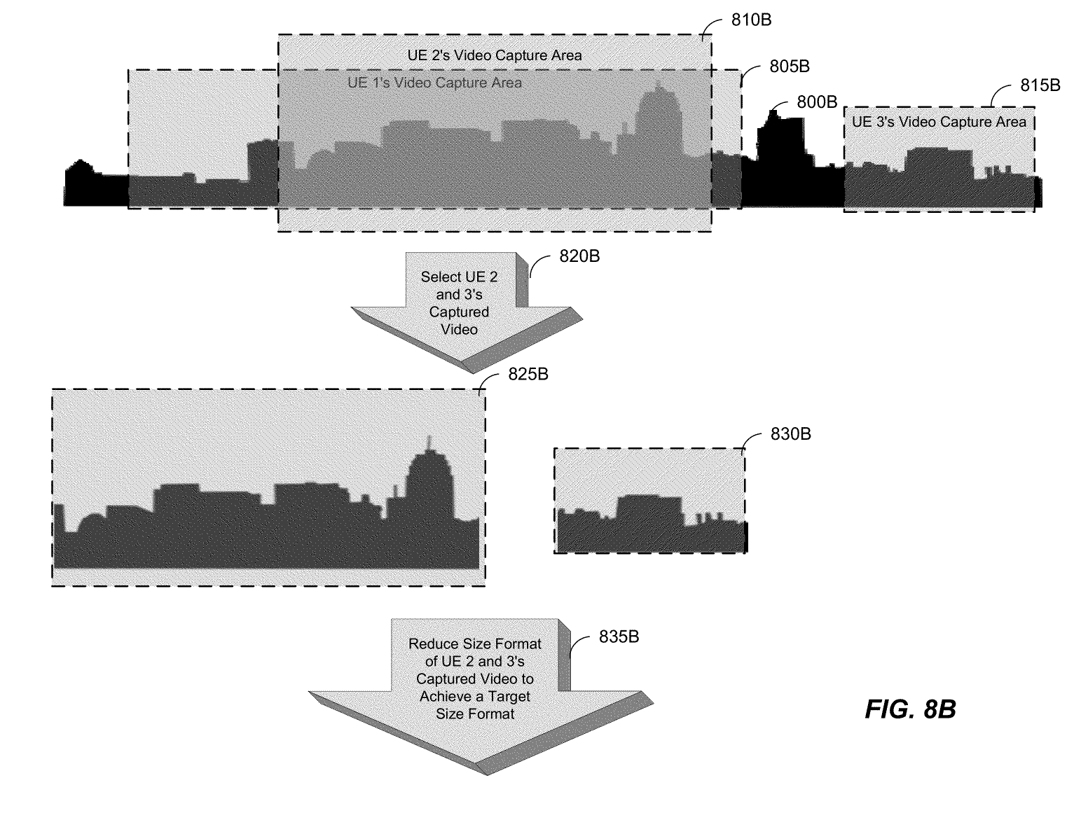

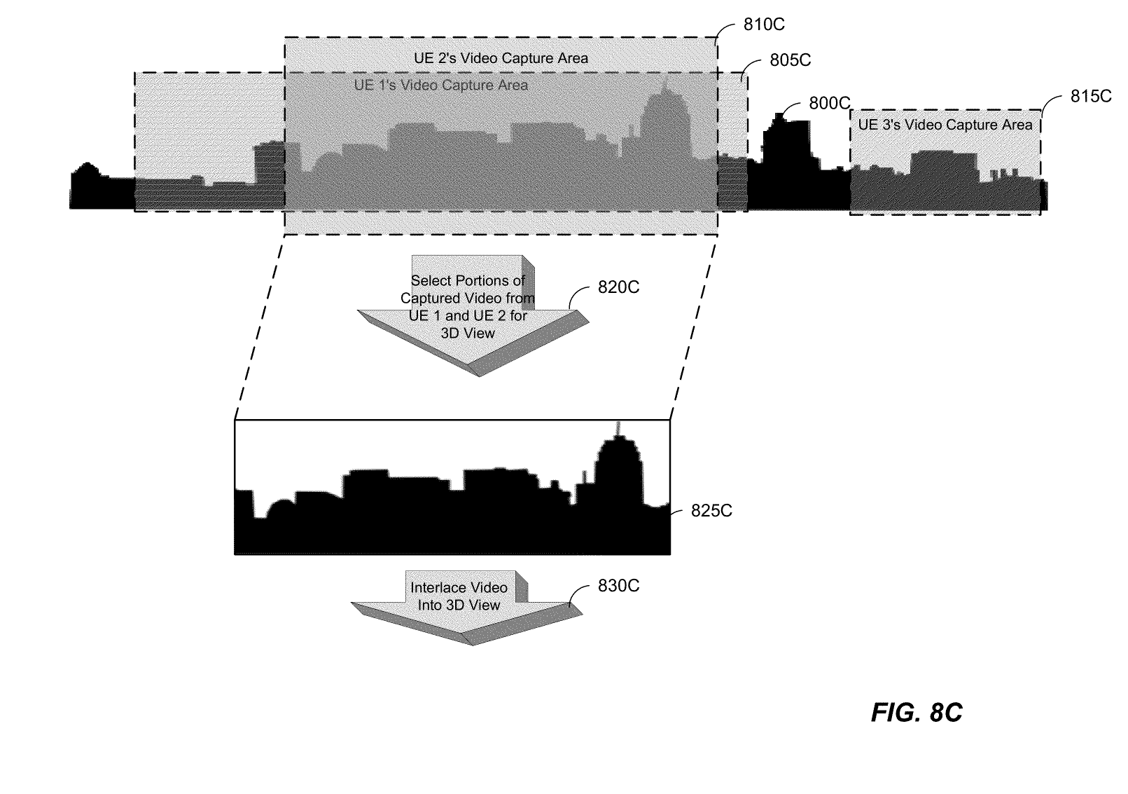

In an example implementation of 630A and 635A, assume that the target format for the interlaced video input feeds is a panoramic view of the visual subject of interest that is composed of multiple video input feeds. An example of interlacing individual video input feeds to achieve a panoramic view in the video output feed is illustrated within FIG. 8A. Referring to FIG. 8A, assume that the visual subject of interest is a city skyline 800A, similar to the city skyline 700A from FIG. 7A. The video input feeds from UEs 1 . . . 3 convey video of the city skyline 800A at portions (or video capture areas) 805A, 810A and 815A, respectively. To form the panoramic view, the application server 170 selects video input feeds that are non-redundant by selecting adjacent or contiguous so that the panoramic view will not have any blatant gaps. In this case, the video input feeds from UEs 1 and 2 are panoramic view candidates (i.e., non-redundant and relevant), but the video input feed of UE 3 is capturing a remote portion of the city skyline 800A that would not be easily interlaced with the video input feeds from UEs 1 or 2 (i.e., non-redundant but also not relevant to a panoramic view in this instance). Thus, the video input feeds from UEs 1 and 2 are selected for panoramic view formation. Next, the relevant portions from the video input feeds of UEs 1 and 2 are selected, 820A. For example, UE 2's video input feed is tilted differently than UE 1's video input feed. The application server 170 may attempt to form a panoramic view that carves out a “flat” or rectangular view that is compatible with viewable aspect ratios at target presentation devices, as shown at 825A. Next, any overlapping portions from 825A can be smoothed or integrated, 830A, so that the resultant panoramic view from 835A corresponds to the panoramic video output feed. While not shown explicitly in FIG. 8A, while multiple video feeds can be interlaced in some manner to produce the video output feed for the panoramic view, a single representative audio feed associated with one of the multiple video feeds can be associated with the video output feed and sent to the target UE(s). In an example, the audio feed associated with the video input feed that is closest to the common visual subject of interest can be selected (e.g., UE 1 in FIG. 7A because UE 1 is closer than UE 2 to the city skyline 700A). Alternatively, the application server 170 can attempt to generate a form of 3D audio that merges two or more audio feeds from the different UEs providing the video input feeds. For example, audio feeds from UEs that are physically close but on different sides of the common visual subject of interest may be selected to form a 3D audio output feed (e.g., to achieve a surround-sound type effect, such that one audio feed becomes the front-left speaker output and another audio feed becomes a rear-right speaker output, and so on).

In another example implementation of 630A and 635A, assume that the target format for the interlaced video input feeds is a plurality of distinct perspective views of the visual subject of interest that reflect multiple video input feeds. An example of interlacing individual video input feeds to achieve the plurality of distinct perspective views in the video output feed is illustrated within FIG. 8B. Referring to FIG. 8B, assume that the visual subject of interest is a city skyline 800B, similar to the city skyline 700A from FIG. 7A. The video input feeds from UEs 1 . . . 3 convey video of the city skyline 800B at portions (or video capture areas) 805B, 810B and 815B, respectively. To select the video input feeds to populate the plurality of distinct perspective views in the video output feed, the application server 170 selects video input feeds that show different portions of the city skyline 800B (e.g., so that users of the target UEs can scroll through the various perspective views until a desired or preferred view of the city skyline 800B is reached). In this case, the video input feeds 805B and 810B from UEs 1 and 2 overlap somewhat and do not offer much perspective view variety, whereby the video input feed 815B shows a different part of the city skyline 800B. Thus, at 820B, assume that the application server 170 selects the video input feeds from UEs 2 and 3, which are represented by 825B and 830B. Next, instead of simply sending the selected video input feeds to the target UEs as the video output feed, the application server 170 compresses the video input feeds from UEs 2 and 3 so as to achieve a target size format, 835B. For example, the target size format may be constant irrespective of the number of perspective views packaged into the video output feed. For example, if the target size format is denoted as X (e.g., X per second, etc.) and the number of perspective views is denoted as Y, then the data portion allocated to each selected video input feed at 835B may be expressed by X/Y. While not shown explicitly in FIG. 8B, while multiple video feeds can be interlaced in some manner to produce the video output feed for the distinct perspective views, a single representative audio feed associated with one of the multiple video feeds can be associated with the video output feed and sent to the target UE(s). In an example, the audio feed associated with the video input feed that is closest to the common visual subject of interest can be selected (e.g., UE 1 in FIG. 7A because UE 1 is closer than UE 2 to the city skyline 700A), or the audio feed associated with the current perspective view that is most prominently displayed at the target UE can be selected. Alternatively, the application server 170 can attempt to generate a form of 3D audio that merges two or more audio feeds from the different UEs providing the video input feeds. For example, audio feeds from UEs that are physically close but on different sides of the common visual subject of interest may be selected to form a 3D audio output feed (e.g., to achieve a surround-sound type effect, such that one audio feed becomes the front-left speaker output and another audio feed becomes a rear-right speaker output, and so on).

In yet another example implementation of 630A and 635A, assume that the target format for the interlaced video input feeds is a 3D view of the visual subject of interest that is composed of multiple video input feeds. An example of interlacing individual video input feeds to achieve a 3D view in the video output feed is illustrated within FIG. 8C. Referring to FIG. 8C, assume that the visual subject of interest is a city skyline 800C, similar to the city skyline 700A from FIG. 7A. The video input feeds from UEs 1 . . . 3 convey video of the city skyline 800C at portions (or video capture areas) 805C, 810C and 815C, respectively. To form the 3D view, the application server 170 selects video input feeds that are overlapping so that the 3D view includes different perspectives of substantially the same portions of the city skyline 800C. In this case, the video input feeds from UEs 1 and 2 are 3D view candidates, but the video input feed of UE 3 is capturing a remote portion of the city skyline 800C that would not be easily interlaced with the video input feeds from UEs 1 or 2 into a 3D view. Thus, the video input feeds from UEs 1 and 2 are selected for 3D view formation. Next, the relevant portions from the video input feeds of UEs 1 and 2 are selected, 820C (e.g., the overlapping portions of UE 1 and 2's video captures areas so that different perspectives of the same city skyline portions can be used to produce a 3D effect in the combined video). 825C shows the overlapping portions of UE 1 and 2's video capture areas which can be used to introduce a 3D effect. Next, the overlapping portion of UE 1 and 2's video capture areas are interlaced so as to introduce the 3D effect, 830C. Regarding the actual 3D formation, a number of off-the-shelf 2D-to-3D conversion engines are available for implementing the 3D formation. These off-the-shelf 2D-to-3D conversion engines (e.g., Faceworx, etc.) rely upon detailed information of the individual 2D feeds and also have requirements with regard to acceptable 2D inputs for the engine. In this embodiment, the location, orientation and/or format information provided by the UE capturing devices permits video input feeds suitable for 3D formation to be selected at 630A (e.g., by excluding video input feeds which would not be compatible with the 3D formation, such as redundant orientations and so forth). Further, while not shown explicitly in FIG. 8C, while multiple video feeds can be interlaced in some manner to produce the video output feed for the 3D view, a single representative audio feed associated with one of the multiple video feeds can be associated with the video output feed and sent to the target UE(s). In an example, the audio feed associated with the video input feed that is closest to the common visual subject of interest can be selected (e.g., UE 1 in FIG. 7A because UE 1 is closer than UE 2 to the city skyline 700A), or the audio feed associated with the current perspective view that is most prominently displayed at the target UE can be selected. Alternatively, the application server 170 can attempt to generate a form of 3D audio that merges two or more audio feeds from the different UEs providing the video input feeds. For example, audio feeds from UEs that are physically close but on different sides of the common visual subject of interest may be selected to form a 3D audio output feed (e.g., to achieve a surround-sound type effect, such that one audio feed becomes the front-left speaker output and another audio feed becomes a rear-right speaker output, and so on).

Turning back to FIG. 6A, after the selected video input feeds are interlaced so as to produce the video output feed that conforms to the target format (e.g., multiple perspectives with target aggregate file size or data rate, panoramic view, 3D view, etc.), the video output feed is transmitted to target UEs 4 . . . N in accordance with the target format, 640A. UEs 4 . . . N receive and present the video output feed, 645A.

FIGS. 6B and 6C illustrate alternative implementations of the video input feed interlace operation of 635A of FIG. 6A in accordance with embodiments of the invention. Referring to FIG. 6B, each selected video input feed is first converted into a common format, 600B. For example, if the common format is 720p and some of the video input feeds streamed at 1080p, 600B may include a down-conversion of the 1080p feed(s) to 720p. After the conversion of 600B, portions of the converted video input feeds are combined to produce the video output feed, 605B. The conversion and combining operations of 600B and 605B can be implemented in conjunction with any of the scenarios described with respect to FIGS. 8A-8C, in an example. For example, in FIG. 8A, the conversion of 600B can be applied once the portions to be interlaced into the panoramic view are selected at 820A.

Referring to FIG. 6C, portions of each selected video input feed are first combined in their respective formats as received at the application server 170, 600C. After the combination of 600C, the resultant combined video input feeds are selectively compressed to produce the video output feed, 605C. The combining and conversion operations of 600C and 605C can be implemented in conjunction with any of the scenarios described with respect to FIGS. 8A-8C, in an example. For example, in FIG. 8A, if UE 1's video input feed is 720p and UE 2's video input feed is 1080p, the non-overlapping portions of the selected video input feeds can first be combined as shown in 825A, so that portions contributed by UE 1 are 720p and portions contributed by UE 2 are 1080p. At this point, assuming the target format is 720p, any portions in the combined video input feeds that are at 1080p are compressed so that the video output feed in its totality is compliant with 720p.

FIG. 6D illustrates a continuation of the process of FIG. 6A in accordance with an embodiment of the invention. Referring to FIG. 6D, assume that UEs 1 . . . 3 continue to transmit their respective video input feeds and continue to indicate the respective locations, orientations of format of their respective video input feeds, 600D. At some point, the application server 170 selects a different set of video input feeds to combine into the video output feed, 605D. For example, a user of UE 1 may have changed the orientation so that the given visual subject of interest is no longer being captured, or a user of UE 2 may have moved to a location that is too far away from the given visual subject of interest. Accordingly, the application server 170 interlaces the selected video input feeds from 605D into a new video output feed that conforms to the target format, 610D, and transmits the video output feed to the target UEs 4 . . . N in accordance with the target format, 615D. UEs 4 . . . N receive and present the video output feed, 620D.

While FIG. 6D illustrates an example of how the contributing video input feeds in the video output feed can change during the group communication session, FIG. 6E illustrates an example of how individual video input feeds used to populate the video output feed or even the target format itself can be selectively changed for certain target UEs (e.g., from a panoramic view to a 3D view, etc.). The relevant video input feeds may also vary for each different target format (e.g., the video input feeds selected for a panoramic view may be different than the video input feeds selected to provide a variety of representative perspective views or a 3D view).

Accordingly, FIG. 6E illustrates a continuation of the process of FIG. 6A in accordance with another embodiment of the invention. Referring to FIG. 6E, assume that UEs 1 . . . 3 continue to transmit their respective video input feeds and continue to indicate the respective locations, orientations of format of their respective video input feeds, 600E. At some point during the group communication session, UE 4 indicates a request for the application server 170 to change its video output feed from the current target format (“first target format”) to a different target format (“second target format”), 605E. For example, the first target format may correspond to a plurality of low-resolution perspective views of the given visual subject of interest (e.g., as in FIG. 8B), and the user of UE 4 may decide that he/she wants to view one particular perspective view in higher-resolution 3D (e.g., as in FIG. 8C), such that the requested second target format is a 3D view of a particular video input feed or feeds. Further, at some point during the group communication session, UE 5 indicates a request for the application server 170 to change the set of video input feeds used to populate its video output feed, 610E. For example, the first target format may correspond to a plurality of low-resolution perspective views of the given visual subject of interest (e.g., as in FIG. 8B), and the user of UE 5 may decide that he/she wants to view a smaller subset of perspective views, each in a higher resolution. Thus, the request for a different set of video input feeds in 610E may or may not change the target format, and the request for a different target format as in 605E may or may not change the contributing video input feeds in the video output feed. Also, in FIG. 6E, assume that UEs 6 . . . N do not request a change in their respective video output feeds, 615E.

Referring to FIG. 6E, the application server 170 continues to interlace the same set of video input feeds to produce a first video output feed in accordance with the first (or previously established) target format, similar to 635A of FIG. 6A, 620E. The application server 170 also selects and then interlaces a set of video input feeds (which may be the same set of video input feeds from 620E or a different set) so as to produce a second video output feed in accordance with the second target format based on UE 4's request from 605E, 625E. The application server 170 also selects and then interlaces another set of video input feeds (different from the set of video input feeds from 620E) so as to produce a third video output feed in accordance with a target format that accommodates UE 5's request from 610E, 630E. After producing the first through third video output feeds, the application server 170 transmits the first video output feed to UEs 6 . . . N, 635E, the application server 170 transmits the second video output feed to UE 4, 640E, and the application server 170 transmits the third video output feed to UE 5, 645E. Each of UEs 4 . . . N then present their respective video output feeds at 650E, 655E and 660E, respectively.

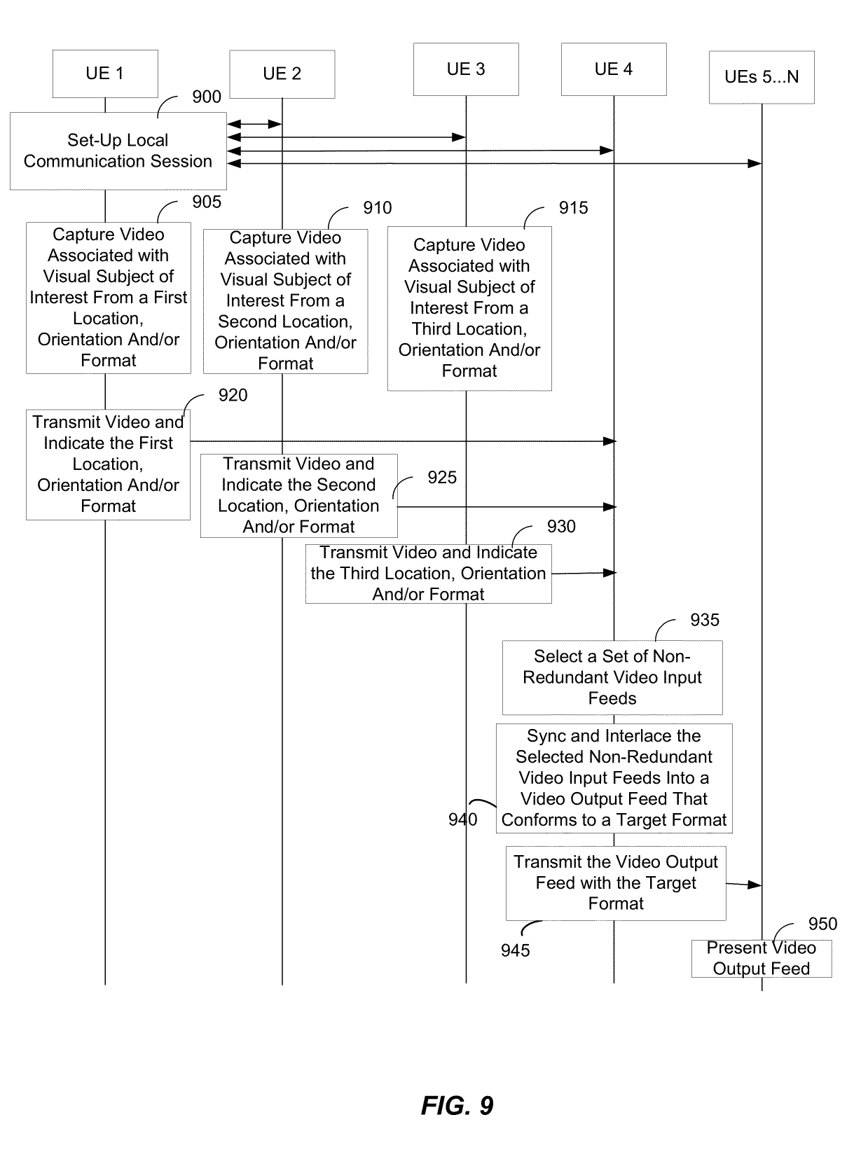

While the embodiments of FIGS. 6A through 8C have thus far been described with respect to server-arbitrated group communication sessions, other embodiments are directed to a peer-to-peer (P2P) or ad-hoc sessions that are at least partially arbitrated by one or more UEs over a PAN. Accordingly, FIG. 9 illustrates a process of a given UE that selectively combines a plurality of video input feeds from a plurality of video capturing devices to form a video output feed that conforms to a target format during a PAN-based group communication session in accordance with an embodiment of the invention.

Referring to FIG. 9, UEs 1 . . . N set-up a local group communication session, 900. The local group communication session can be established over a P2P connection or PAN, such that the local group communication session does not require server arbitration, although some or all of the video exchanged during the local group communication session can later be uploaded or archived at the application server 170. For example, UEs 1 . . . N may be positioned in proximity to a sports event and can use video shared between the respective UEs to obtain views or perspectives of the sports game that extend their own viewing experience (e.g., a UE positioned on the west side of a playing field or court can stream its video feed to a UE positioned on an east side of the playing field or court, or even to UEs that are not in view of the playing field or court). Thus, the connection that supports the local group communication session between UEs 1 . . . N is at least sufficient to support an exchange of video data.

Referring to FIG. 9, similar to 600A through 610A of FIG. 6A, UE 1 captures video associated with a given visual subject of interest from a first location, orientation and/or format, 905, UE 2 captures video associated with the given visual subject of interest from a second location, orientation and/or format, 910, and UE 3 captures video associated with the given visual subject of interest from a third location, orientation and/or format, 915. Unlike FIG. 6A, instead of uploading their respective captured video to the application server 170 for dissemination to the target UEs, UEs 1 . . . 3 each transmit their respective captured video along with indications of the associated locations, orientations and formats to a designated arbitrator or “director” UE (i.e., in this case, UE 4) at 920, 925 and 930, respectively. Next, except for being performed at UE 4 instead of the application server 170, 935 through 945 substantially correspond to 630A through 640A of FIG. 6A, which will not be discussed further for the sake of brevity. After UE 4 transmits the video output feed to UEs 5 . . . N at 945, UEs 5 . . . N each present the video output feed, 950.

While FIG. 9 is illustrated such that a single UE is designated as director and is responsible for generating a single video output feed, it will be appreciated that variations of FIGS. 6D and/or 6E could also be implemented over the local group communication session, such that UE 4 could produce multiple different video output feeds for different target UEs or groups of UEs. Alternatively, multiple director UEs could be designated within the local group communication, with different video output feeds being generated by different director UEs.

Further, while FIGS. 5-9 are described above whereby the video output feed(s) are sent to the target UEs in real-time or contemporaneous with the video capturing UEs providing the video media, it will be appreciated that, in other embodiments of the invention, the video input feeds could be archived, such that the video output feed(s) could be generated at a later point in time after the video capturing UEs are no longer capturing the given visual subject of interest. Alternatively, a set of video output feeds could be archived instead of the “raw” video input feeds. Alternatively, a late-joining UE could access archived portions of the video input feeds and/or video output feeds while the video capturing UEs are still capturing and transferring their respective video input feeds.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for selectively combining video data at a communications device, comprising:
receiving a plurality of video input feeds from a plurality of video capturing devices, each of the received plurality of video input feeds providing a different perspective of a given visual subject of interest;
receiving, for each of the received plurality of video input feeds, indications of (i) a location an associated video capturing device, (ii) an orientation of the associated video capturing device and (iii) a format of the received video input feed;
selecting a set of the received plurality of video input feeds;
interlacing the selected video input feeds into a video output feed that conforms to a target format; and
transmitting the video output feed to a set of target video presentation devices.

2. The method of claim 1,
wherein the selected video input feeds are each two-dimensional (2D),
wherein the target format corresponds to a three-dimensional (3D) view of the given visual subject of interest that is formed by interlacing portions of the selected video input feeds.

3. The method of claim 1, wherein the target format corresponds to a panoramic view of the given visual subject of interest that is formed by interlacing non-overlapping portions of the selected video input feeds.

4. The method of claim 1,
wherein the target format corresponds to an aggregate size format for the video output feed, further comprising:
compressing one or more of the selected video input feeds such that the video output feed achieves the aggregate size format after the interlacing.

5. The method of claim 4, wherein the aggregate size format for the video output feed remains the same irrespective of a number of the selected video input feeds being interlaced into the video output feed such that a higher number of selected video input feeds is associated with additional compression per video input feed and a lower number of selected video input feeds is associated with less compression per video input feed.

6. The method of claim 1, wherein the communications device corresponds to a server that is remote from the plurality of video capturing devices and the set of target video presentation devices.

7. The method of claim 1,
wherein the plurality of video capturing devices and the set of target video presentation devices each correspond to user equipments (UE) engaged in a local group communication session, and
wherein the communications device corresponds to a given UE that is also engaged in the local group communication session.

8. The method of claim 1, further comprising:
selecting a different set of the received plurality of video input feeds;
interlacing the selected different video input feeds into a different video output feed that conforms to a given target format; and
transmitting the different video output feed to a different set of target video presentation devices.

9. The method of claim 8, wherein the given target format corresponds to the target format.

10. The method of claim 8, wherein the given target format does not correspond to the target format.

11. The method of claim 1, further comprising:
selecting a given set of the received plurality of video input feeds;
interlacing the selected given video input feeds into a different video output feed that conforms to a different target format; and
transmitting the different video output feed to a different set of target video presentation devices.

12. The method of claim 11, wherein the selected given video input feeds corresponds to the selected video input feeds.

13. The method of claim 11, wherein the selected given video input feeds does not correspond to the selected video input feeds.

14. The method of claim 1, wherein the received indications of location include an indication of absolute location for at least one of the plurality of video capturing devices.

15. The method of claim 1, wherein the received indications of location include an indication of relative location between two or more of the plurality of video capturing devices.

16. The method of claim 1, further comprising:
syncing the selected video input feeds in a time-based or event-based manner,
wherein the interlacing is performed for the synced video input feeds.

17. The method of claim 16, wherein the selected video input feeds are synced in the time-based manner based on timestamps indicating when the selected video input feeds were captured at respective video capturing devices, when the selected video input feeds were transmitted by the respective video capturing devices and/or when the selected video input feeds were received at the communications device.

18. The method of claim 16, wherein the selected video input feeds are synced in the event-based manner.

19. The method of claim 18, wherein the syncing includes:
identifying a set of common tracking objects within the selected video input feeds;
detecting an event associated with the set of common tracking objects that is visible in each of the selected video input feeds; and
synchronizing the selected video input feeds based on the detected event.

20. The method of claim 19, wherein the set of common tracking objects includes a first set of fixed common tracking objects and a second set of mobile common tracking objects.

21. The method of claim 1, wherein the selecting includes:
characterizing each of the received plurality of video input feeds as being (i) redundant with respect to at least one other of the received plurality of video input feeds for the target format, or (ii) non-redundant;
forming a set of non-redundant video input feeds by (i) including one or more video input feeds from the received plurality of video input feeds characterized as non-redundant, and/or (ii) including a single representative video input feed for each set of video input feeds from the received plurality of video input feeds characterized as redundant,
wherein the selected video input feeds correspond to the set of non-redundant video input feeds.

22. A communications device configured to selectively combine video data, comprising:
means for receiving a plurality of video input feeds from a plurality of video capturing devices, each of the received plurality of video input feeds providing a different perspective of a given visual subject of interest;
means for receiving, for each of the received plurality of video input feeds, indications of (i) a location an associated video capturing device, (ii) an orientation of the associated video capturing device and (iii) a format of the received video input feed;
means for selecting a set of the received plurality of video input feeds;
means for interlacing the selected video input feeds into a video output feed that conforms to a target format; and
means for transmitting the video output feed to a set of target video presentation devices.

23. The communications device of claim 22, wherein the communications device corresponds to a server that is remote from the plurality of video capturing devices and the set of target video presentation devices.

24. The communications device of claim 22,
wherein the plurality of video capturing devices and the set of target video presentation devices each correspond to user equipments (UE) engaged in a local group communication session, and
wherein the communications device corresponds to a given UE that is also engaged in the local group communication session.

25. A communications device configured to selectively combine video data, comprising:
logic configured to receive a plurality of video input feeds from a plurality of video capturing devices, each of the received plurality of video input feeds providing a different perspective of a given visual subject of interest;
logic configured to receive, for each of the received plurality of video input feeds, indications of (i) a location an associated video capturing device, (ii) an orientation of the associated video capturing device and (iii) a format of the received video input feed;
logic configured to select a set of the received plurality of video input feeds;
logic configured to interlace the selected video input feeds into a video output feed that conforms to a target format; and
logic configured to transmit the video output feed to a set of target video presentation devices.

26. The communications device of claim 25, wherein the communications device corresponds to a server that is remote from the plurality of video capturing devices and the set of target video presentation devices.

27. The communications device of claim 25,
wherein the plurality of video capturing devices and the set of target video presentation devices each correspond to user equipments (UE) engaged in a local group communication session, and
wherein the communications device corresponds to a given UE that is also engaged in the local group communication session.

28. A non-transitory computer-readable medium containing instructions stored thereon, which, when executed by a communications device configured to selectively combine video data, causes the communications device to perform operations, the instructions comprising:
at least one instruction for causing the communications device to receive a plurality of video input feeds from a plurality of video capturing devices, each of the received plurality of video input feeds providing a different perspective of a given visual subject of interest;
at least one instruction for causing the communications device to receive, for each of the received plurality of video input feeds, indications of (i) a location an associated video capturing device, (ii) an orientation of the associated video capturing device and (iii) a format of the received video input feed;
at least one instruction for causing the communications device to select a set of the received plurality of video input feeds;
at least one instruction for causing the communications device to interlace the selected video input feeds into a video output feed that conforms to a target format; and
at least one instruction for causing the communications device to transmit the video output feed to a set of target video presentation devices.

29. The non-transitory computer-readable medium of claim 28, wherein the communications device corresponds to a server that is remote from the plurality of video capturing devices and the set of target video presentation devices.

30. The non-transitory computer-readable medium of claim 28,
wherein the plurality of video capturing devices and the set of target video presentation devices each correspond to user equipments (UE) engaged in a local group communication session, and
wherein the communications device corresponds to a given UE that is also engaged in the local group communication session.
